(19) United States
(12) Patent Application Publication
(10) Pub. No.: US 2009/0157366 A1
(43) Pub. Date: Jun. 18, 2009

(54) System for simulating digital watercolor image and method therefor

(75) Inventors: Seung Hyup Shin, Daejeon (KR); Bon Ki Koo, Daejeon (KR); Ji Hyung Lee, Daejeon (KR); Hee Jeong Kim, Daejeon (KR); Bo Youn Kim, Daejeon (KR); Yoon-Seok Choi, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/314,035

(22) Filed: Dec. 3, 2008

(30) Foreign Application Priority Data
Dec. 12, 2007 (KR) 10-2007-0129388

(51) Int. Cl. G06G 7/50; G06G 7/48

(52) U.S. Cl. 703/9; 703/6

(57) ABSTRACT

A method for simulating digital watercolor image includes: receiving a background texture on a virtual canvas where a watercolor image will be painted; receiving parameters for fluid simulation; and creating brushstrokes by a mouse pointer's movement on the virtual canvas. Further, the method includes converting coordinates of the brushstrokes on the virtual canvas to fit into simulation grids; calculating movement of colors and water through the fluid simulation by using the parameters and the brushstrokes; and simulating the watercolor image based on the brushstrokes by using the calculated movement of the colors and water.

### CROSS-REFERENCE TO RELATED APPLICATION(S)

The present invention claims priority of Korean Patent Application No. 10-2007-0129388, filed on Dec. 12, 2007, which is incorporated herein by reference.

### FIELD OF THE INVENTION

The present invention relates to a method for producing two-dimensional images based on a computer; and, more particularly, to a system for simulating digital watercolor image and method therefor capable of representing realistic watercolor movement on a computer-based virtual canvas using brush information generated using a mouse.

This work was supported by the IT R&D program of MIC/IITA [2005-S-082-03, Development of Non-Photorealistic Animation Technology].

### BACKGROUND OF THE INVENTION

In general, computer graphics techniques have been developed in conjunction with production of non-realistic images such as cartoon or artistic images as well as production of realistic images. As the market for digital contents such as movies, animations, TV or games has been rapidly expanding, such non-realistic images are becoming increasingly important. In particular, there have been extensive researches on executing traditional drawings, e.g., watercolor paintings, oil paintings and the like, on a computer-based virtual canvas.

Researches on watercolor rendering are broadly classified into two categories. One is to calculate the movement of watercolors by constructing a physical model describing the interaction among colors, water and paper and then by simulating the physical model. The other is to obtain watercolor feeling by using image processing techniques without a physical model.

According to techniques using physical simulations, movement of colors and water is generally expressed by applying fluid simulation equations. The Navier-Stokes equations and Lattice Boltzmann equation describe the movement of fluid in detail and have been widely applied in the computer graphics field in recent years.

The main problem in solving such fluid simulation equations with a computer is the time to calculate the equations. Too much time is consumed to accurately solve the fluid equations even in a simple environment model. However, the important issue in the computer graphics field is not to get an accurate solution of the equation but to get a calculation that people realistically understand. Therefore, the solution speed can be improved by making a part of the fluid equations, which are difficult to calculate, simpler at the expense of introducing some error.

Various image processing techniques without using a physical model are used to produce resultant image which are as similar as possible to paintings in watercolors. Perlin noise is used instead of calculation of the complicated simulations in order to represent the sophisticated movement of watercolors. In addition, a texture prepared in advance is compounded with brush strokes to form a final image. An edge detection technique of the traditional image processing techniques is also used in order to simulate clumping at the edge of watercolors painted. These techniques have an advantage of very short calculation time and are applicable even in a low end computer.

However, to obtain realistic images by using the image processing techniques without calculating real physical phenomena is limited and further the resultant images do not express various sophisticated effects of the real watercolor painting.

### SUMMARY OF THE INVENTION

In view of the above, the present invention provides a system for simulating digital watercolor image and method therefor capable of representing the realistic watercolor movement through fluid simulation using brush information generated from a mouse in simulating various diffusion profiles of watercolors on a computer-based virtual canvas.

In accordance with a first aspect of the present invention, there is provided a system for simulating digital watercolor image including: a pre-processing unit for performing a sampling of brush positions by a mouse pointer's movement on a virtual canvas where a watercolor image will be painted and for creating brushstrokes due to the mouse pointer's movement; and a graphic processing unit for simulating the watercolor image based on the brushstrokes on the virtual canvas through fluid simulation using the brushstrokes, a background texture of the virtual canvas and parameters for the fluid simulation.

In accordance with a second aspect of the present invention, there is provided a method for simulating digital watercolor image including: receiving a background texture on a virtual canvas where a watercolor image will be painted; receiving parameters for fluid simulation; creating brushstrokes by a mouse pointer's movement on the virtual canvas; converting coordinates of the brushstrokes on the virtual canvas to fit into simulation grids; calculating movement of colors and water through the fluid simulation by using the background texture, the parameters and the brushstrokes; and simulating the watercolor image based on the brushstrokes on the virtual canvas by using the calculated movement of the colors and water.

### BRIEF DESCRIPTION OF THE DRAWINGS

The objects and features of the present invention will become apparent from the following description of embodiments given in conjunction with the accompanying drawings, in which:

FIG. 1 is a schematic block diagram of a digital watercolor image simulation system of the embodiment of the present invention;

FIG. 2 is a flow chart illustrating a fluid simulation operation of the graphic processing unit shown in FIG. 1; and

FIG. 3 shows an example of a virtual canvas in accordance with the embodiment of the present invention.

### DETAILED DESCRIPTION OF THE EMBODIMENTS

Hereinafter, embodiments of the present invention will be described in detail with reference to the accompanying drawings which form a part hereof.

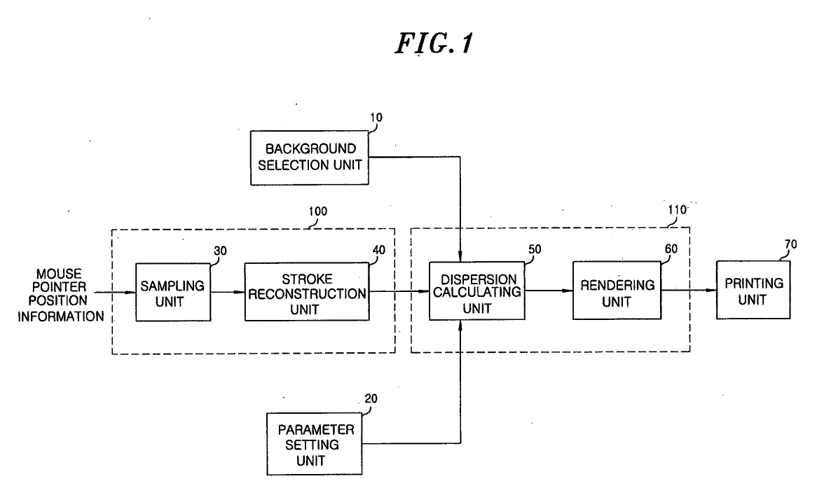

FIG. 1 is a schematic block diagram of a system for simulating two-dimensional digital watercolor images based on a computer in accordance with the embodiments. The present system includes a background selection unit 10, a parameter selection unit 20, a pre-processing unit 100, a graphic processing unit 110 and a printing unit 70.

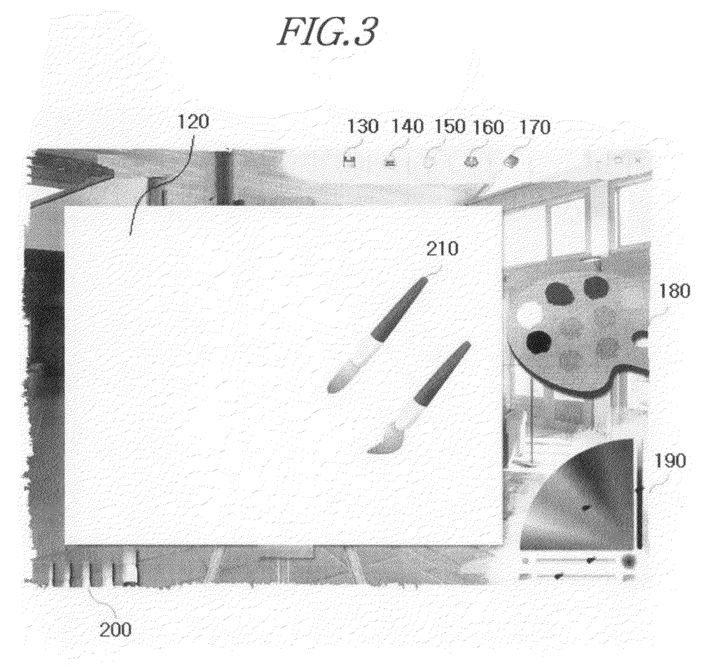

The background selection unit 10 serves to select a paper texture for a primary background on a virtual canvas. For example, referring to FIG. 3, there is illustrated a virtual canvas screen for fluid simulation. The virtual canvas screen is displayed on a monitor (not shown) by virtue of any graphics application embedded in a computer. The virtual canvas screen introduces a user interface so that a user can use drawing tools easily. More specifically, the virtual canvas screen includes a virtual canvas 120, a brush-shaped mouse pointer 210, a plurality of icons such as a save icon 130, a print icon 140, a clear icon 150, a preferences icon 160, a help icon 170, color/water amount 180, color spreading 190 and a brush size 200.

For the user interface provides tools and processes similar to those of a real drawing by analyzing a real drawing process. Therefore, the user can draw what the user wants by clicking the mouse on the virtual canvas 120 and by drawing brushstrokes with the brush-shaped mouse pointer 210.

Further, the user can set parameters of the fluid simulation through icons such as the brush size 200, the watercolor or water amount 180 or the color spreading 190 on the virtual canvas screen. The user can also save a final image in bitmap format using the save icon 130 or print it out using the print icon 140.

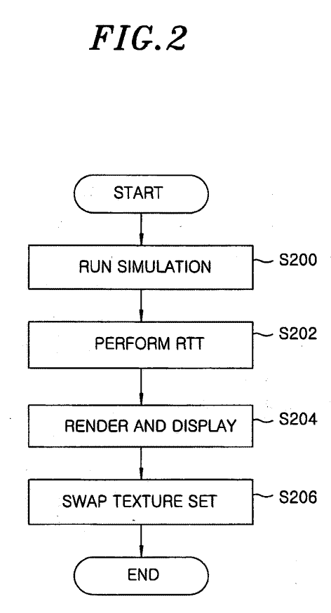

Referring back to FIG. 2, the parameter setting unit 20 sets simulation parameters needed for fluid simulation. The simulation parameters includes a brush size, color amount or water amount, which are optionally entered by a user through the brush size 200, the color/water amount 130, the print icon 140, a clear icon 150, a preferences icon 160, a help icon 170 respectively, on the virtual canvas screen.

When clicking the mouse on the virtual canvas 120, position information will be created depending on the brush-shaped mouse pointer 210. Position information representing the trace of the mouse pointer 210, which is created by a user's hand movement, is provided to the central processing unit 100. In the central processing unit 100, a sampling unit 30 discretely samples the positions of the mouse pointer 210 on the virtual canvas 120 depending on the mouse pointer's movement. The stroke reconstruction unit 40 produces soft brushstrokes for the movement of the mouse pointer 210 by reconstructing two-dimensional spline curves using the sampled discrete positions.

In the present invention, the shape of a brush should be drawn at the same positions of the mouse pointer 210 as smooth as possible in order to improve the quality of the watercolor images. Therefore, the continuous movement of the mouse rather than using the sampled discrete positions is recalculated and the recalculated positions are employed to represent the position of the brush.

More specifically, if a user drags a mouse, the sampling unit 30 performs a discrete sampling of mousers positions at a sampling rate of, e.g., about 100 to 120 samples per second. If mouse movement is slow, a soft watercolor simulation can be obtained by combining brushstrokes at the positions of the mouse pointer 210.

However, displacement between the sampled mouse positions is large in case of a normal mouse movement, which results in that the brushstrokes are disconnected. To solve this problem, two-dimensional spline curve is reconstructed by using the sampled discrete positions to obtain high-density discrete positions. Therefore, in the stroke reconstruction unit 40, the soft brushstrokes are created by virtue of the high-density discrete positions. In addition to, satisfying results in terms of the speed and quality can be achieved by using cubic spline curves among various spline curves. The created brushstrokes by the stoke reconstruction unit 40 are then provided to the graphic processing unit 110.

The graphic processing unit 110 performs fluid simulation on the brush stroke using the parameters such as the brush size and color/water amount. However, such brushstrokes are calculated based on local coordinates of the virtual canvas 120. Therefore, the graphic processing unit 120 converts the local coordinates such that the brushstrokes can be fit into simulation grids for use in the fluid simulation as will be discussed below. Further, to maximize the utilization of the virtual canvas 120, it is required to achieve fast calculation enough such that a compound of the brushstrokes and the simulation parameters are made in real time. For this, all calculations of the application programs are processed in the central processing unit 100 and the calculation based on the fluid simulation are separately performed in the graphic processing unit 110, as described in FIG. 1. Moreover, two functions of the most recent shader model, i.e. Render-to-Texture (hereinafter, referred to as “RTT”) and early Z-cull are used to achieve fast calculations.

Once each fluid simulation is completed, the simulation result is copied for the next process. However, it takes a quite long time to use the conventional Copy-to-Texture (CTT) technique. Therefore, the RTT and double buffering with much less time for copying are used in accordance with the present invention. That is, once each fluid simulation is completed, the simulation result is copied using the RTT and double buffering to accelerate the simulation speed.

Upon receiving the background textures from the background selection unit 10, the simulation parameters from the parameter setting unit 20 and the brushstrokes from the stroke reconstruction unit 40, a dispersion calculating unit 50 of the graphic processing unit 110 calculates the movement of the colors and water through the fluid simulation to simulate a watercolor image for every frame. A rendering unit 60 renders the color and water amount calculated to the simulated watercolor image at each center of the grid cells to thereby create a final watercolor image.

A printing unit 70 prints out the watercolor image in response to the user's request.

FIG. 2 illustrates a concept of a real-time fluid simulation operation performed in the graphic processing unit 110 shown in FIG. 1. The brushstroke generation and real-time fluid simulation operation will be described in detail by referring to FIGS. 1 and 2.

First, a paper texture to be used for a primary background on a virtual canvas 120 is selected by a user through the background selection unit 10. In addition, parameters for the fluid simulation such as a brush size, color amount or water amount are set by a user through the parameter setting unit 20.

If a user drags a mouse on the virtual canvas 120, positions of the mouse pointer 210 on a virtual canvas is discretely sampled by the sampling unit 30 and brushstrokes corresponding to the sampled positions are created by the stroke reconstruction unit 40. Upon receiving the primary background, the parameters and the brushstrokes, in step 200, the dispersion unit 50 performs the fluid simulation using the primary background, the parameters and the brushstrokes.

Once each fluid simulation is completed, in step S202, the resultant of the simulated watercolor image is copied for the next process. That is, once each fluid simulation is completed, the simulation result is copied using the RTT and double buffering to accelerate the simulation speed.

After that, in step S204, the simulated watercolor image in this way is rendered to be displayed on the virtual canvas 210.

Finally, in step S206, the texture set is swapped.

These processes including the steps S200 to S206 are repeated in each simulation. Furthermore, in the present invention the early Z-cull technique is employed to exclude grid cells with no water from the simulation calculation in advance by comparing values of depth buffers, thereby improving efficiency.

While the invention has been shown and described with respect to the embodiments, it will be understood by those skilled in the art that various changes and modifications may be made without departing from the scope of the invention as defined in the following claims.

What is claimed is:

1. A method for simulating digital watercolor image comprising:
receiving a background texture on a virtual canvas where a watercolor image will be painted;
receiving parameters for fluid simulation;
creating brushstrokes by a mouse pointer's movement on the virtual canvas;
converting coordinates of the brushstrokes on the virtual canvas to fit into simulation grids;
calculating movement of colors and water through the fluid simulation by using, the parameters and the brushstrokes; and
simulating the watercolor image based on the brushstrokes by using the calculated movement of the colors and water.

2. The method of claim 1, wherein creating the brushstrokes, comprises sampling positions of the mouse pointer to produce the brushstrokes on the virtual canvas.

3. The method of claim 1, wherein creating the brushstrokes, the brushstrokes due to the mouse pointer's movement are produced by reconstructing two-dimensional spline curves.

4. The method of claim 1, wherein the parameters for the fluid simulation include a brush size, color amount or water amount.

5. The method of claim 1, wherein the movement of the colors and water based on the brushstrokes is calculated through the fluid simulation for every frame.

6. The method of claim 1, wherein the fluid simulation employs the lattice Boltzmann Equation.

7. The method of claim 5, wherein the calculated movement of the colors and water is stored by the RTT and double buffering.

8. A system for simulating digital watercolor image comprising:
a pre-processing unit for performing a sampling of positions of a mouse pointer's movement on a virtual canvas where a watercolor image will be painted and for creating brushstrokes due to the mouse pointer's movement; and
a graphic processing unit for simulating the watercolor image based on the brushstrokes on the virtual canvas through fluid simulation using the brushstrokes, a background texture of the virtual canvas and parameters for the fluid simulation.

9. The system of claim 8, wherein the parameter for fluid simulation include information on color and water amount;
wherein the graphic processing unit updates the watercolor image on the virtual canvas by calculating movement of colors and water using the information on color and water amount for every frame.

10. The system of claim 9, wherein the parameter for fluid simulation further includes a brush size, and
wherein the graphic processing unit calculates the movement of the colors and water based on the brush size.

11. The system of claim 10, wherein the fluid simulation employs the lattice Boltzmann Equation.

12. The system of claim 9, wherein the calculated movement of the colors and water is stored by the RTT and double buffering.

13. The system of claim 8, wherein the brushstrokes are obtained by sampling positions of the mouse pointer.

14. The system of claim 8, wherein the watercolor image is obtained by reconstructing two-dimensional spline curves.
